(19) United States
(12) Patent Application Publication
(10) Pub. No.: US 2010/0091332 A1
(43) Pub. Date: Apr. 15, 2010

(54) Image Forming Apparatus and Image Forming Method

(75) Inventor: Koichi ISHII, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/566,470

(22) Filed: Sep. 24, 2009

(30) Foreign Application Priority Data
Oct. 10, 2008 (JP) 2008-263840

(51) Int. Cl. G09G 3/30

(52) U.S. Cl. 358/3.06

(57) ABSTRACT

An image forming apparatus includes an image data input unit to which image data is input, a latent image carrier, an exposure head having a luminous element disposed in a first direction, and an imaging optical system for imaging light from the luminous element onto the latent image carrier, and an image processing unit that screen-processes the image data by using a screen table having a first screen pixel formed by n (n is an integer number equal to or more than 1) luminous element spots in a first direction and a second screen pixel formed by m (m is an integer number different from n) luminous element spots in the first direction.

### BACKGROUND

1. Technical Field

The present invention relates to an image forming apparatus and an image forming method which can reduce deterioration in image quality when screen data is utilized.

2. Related Art

An image forming apparatus of electrophotographic type is known, in which an latent image is formed on an image carrier (i.e., photosensitive body) by using an exposure head including at least two luminous elements and an imaging optical system for imaging light from the luminous elements. A technique of employing a lens (ML) having negative optical magnification in the imaging optical system has been developed. JP-A-2008-049692 discloses a line head including the lens as an imaging optical system, and an image forming apparatus using the line head.

There is a case where screen processing is carried out by screen data in the image forming apparatus using a lens array (MLA). In addition, if the number of dots representing one line is increased in an axial direction of the photosensitive body, a long MLA head is required. In this instance, two or more MLAs having a certain length may be connected to each other to form the long MLA head. In the case where the MLAs are connected, the image quality is deteriorated due to variation between pitches of connected portions of the MLAs or a resist difference between the MLAs. There is a problem that a solution for coping with the above case is not disclosed in JP-A-2008-049692.

### SUMMARY

An advantage of some aspects of the invention is to provide an image forming apparatus and an image forming method which can reduce deterioration in image quality when screen data is utilized.

According to an aspect of the invention, there is provided an image forming apparatus including: an image data input unit to which image data is input; a latent image carrier; an exposure head having a luminous element disposed in a first direction, and an imaging optical system for imaging light from the luminous element onto the latent image carrier; and an image processing unit that screen-processes the image data by using a screen table having a first screen pixel formed by n (n is an integer number equal to or more than 1) luminous element spots in a first direction and a second screen pixel formed by m (m is an integer number different from n) luminous element spots in the first direction.

In the image forming apparatus according to the invention, the m is n+1.

In the image forming apparatus according to the invention, the first screen pixel and the second screen pixel are dispersed in the first direction and a second direction orthogonal to the first direction in the screen table.

In the image forming apparatus according to the invention, the imaging optical system has negative optical magnification, and is disposed in the first direction of a lens array.

In the image forming apparatus according to the invention, the lens array is disposed in the first direction;

In the image forming apparatus according to the invention, the screen-processing using the screen table compensates for the deterioration of an image formed on the latent image carrier which is caused by a line of the second direction.

Also, in the image forming apparatus according to the invention, the screen table is formed by a non-stochastic dither.

According to another aspect of the invention, there is provided a method of forming an image including: providing an exposure head having an imaging optical system having negative optical magnification, and a luminous element disposed in a first direction, in which an image is formed in the first direction by the imaging optical system; screen-processing input image data by using a screen table having a first screen pixel formed by n (n is an integer number equal to or more than 1) luminous element spots in the first direction and a second screen pixel formed by m (m is an integer number different from n) luminous element spots in the first direction; forming a latent image on a latent image carrier by using the exposure head; and developing the formed latent image using a developing unit according to the screen-processed data.

### BRIEF DESCRIPTION OF THE DRAWINGS

The invention will be described with reference to the accompanying drawings, wherein like numbers reference like elements.

FIG. 1 is a view explaining an embodiment of the invention.

FIG. 2 is a view explaining an embodiment of the invention.

FIG. 3 is a view explaining a prior art of the invention.

FIG. 4 is a view explaining a prior art of the invention.

FIG. 5 is a view explaining a prior art of the invention.

FIG. 6 is a view explaining a prior art of the invention.

FIG. 7 is a view explaining an embodiment of the invention.

FIG. 8 is a view explaining an embodiment of the invention.

FIG. 9 is a block diagram showing an embodiment of the invention.

FIG. 10 is a cross-sectional view showing the whole configuration of an image forming apparatus employing an electrophotographic process according to the first embodiment of the invention.

FIGS. 11A and 11B are views explaining a prior art of the invention.

FIGS. 12A and 12B are views explaining a prior art of the invention.

FIGS. 13A and 13B are views explaining a prior art of the invention.

FIGS. 14A and 14B are views explaining a prior art of the invention.

FIGS. 15A to 15C are views explaining a prior art of the invention.

FIG. 16 is a view explaining a prior art of the invention.

FIG. 17 is a view explaining a prior art of the invention.

FIG. 18 is a view explaining a prior art of the invention.

### DESCRIPTION OF EXEMPLARY EMBODIMENTS

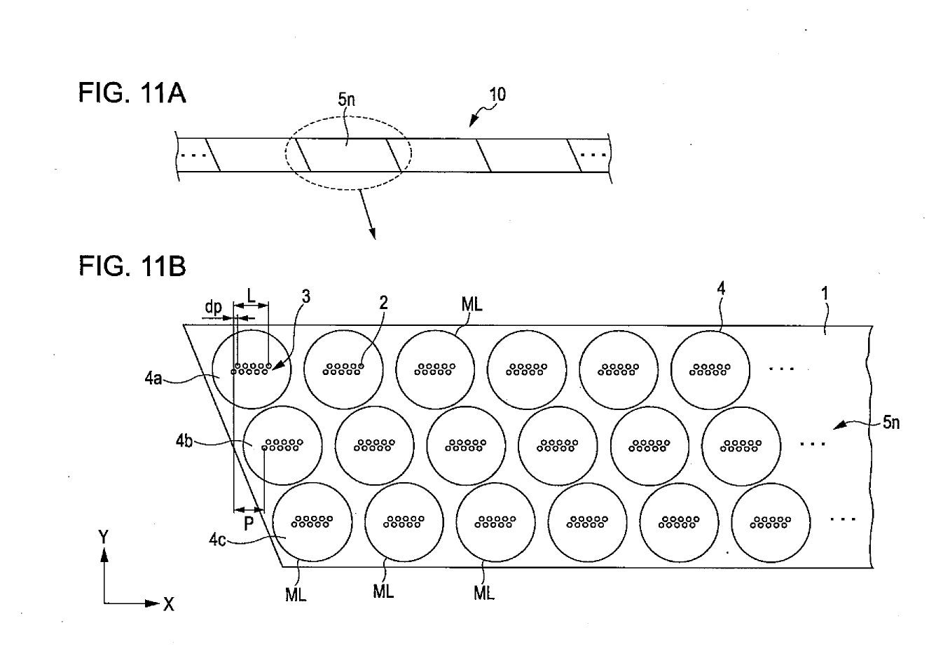

An embodiment of the invention will now be described with reference to the accompanying drawings. FIGS. 11 to 18 are views explaining a prior art of the invention. FIG. 18 shows an arrangement relation between a lens (ML) having negative optical magnification and a luminous element (dot). In FIG. 18, at least two luminous elements 2 are disposed on an ML 4 in an axial direction (X direction) of a photosensitive body and a rotation direction (Y direction) of the photosensitive body. A latent image is formed on the photosensitive body by the luminous elements. In this embodiment of the invention, the X direction is referred to as a first direction, and the Y direction is referred to as a second direction. The luminous elements 2 are designated by reference numerals 1 to N, for the sake of simplicity. In the luminous elements which are placed at the first line in the Y direction, a row 3a of dots designated by 2, 4, . . . , and N from the left to the right in the X direction is formed. In the luminous elements which are placed at two or more lines in the Y direction, rows 3b, 3c and 3d of dots are formed. Finally, in the luminous elements which are placed at the fourth line in the Y direction, a row 3d of dots designated by 1, 3, ( . . . ) is formed.

Two or more lenses (ML) 4 are arranged in the X direction to form a lens array (MLA). Meanwhile, the two or more lenses (ML) may be arranged in the X direction and the Y direction to form the lens array (MLA). Herein, the dots 2 and N are placed in a direction opposite to the X direction of the lenses (ML), and are dots placed at both ends in the X direction.

FIG. 11 is an illustrative view showing an exposure head employing the lens array (MLA). FIG. 11A shows the whole configuration of the MLA head, and FIG. 11B schematically shows a portion of FIG. 11A. FIG. 11A schematically shows a long MLA head (exposure head) 10, and reference numeral 5n denotes a portion of the long MLA head, that is, the MLA. FIG. 11B is an enlarged view of the MLA indicated by the reference numeral 5n.

In FIG. 11B, the exposure head includes at least two luminous elements 2 provided on a substrate 1. Reference numeral 3 denotes a luminous element group composed of at least two luminous elements which are provided on one lens 4a. In the luminous element group 3, at least two luminous elements are disposed in the axial direction X of the photosensitive body and the rotation direction Y of the photosensitive body. Reference numeral 4 denotes a lens (ML), and at least two lenses are disposed in the axial direction X (main scanning direction) of the photosensitive body and the rotation direction Y (sub scanning direction) of the photosensitive body, which form the lens array (MLA) 5n.

In the lens 4a, L denotes a width of one row of the luminous elements disposed in the X direction inside one lens, dp denotes an interval between the luminous elements (dots), and P denotes a distance between a leading dot of the lens 4a and a leading dot of a lens 4b adjacent to the lens 4a in the Y direction, the distance being measured between the leading dots in the X direction.

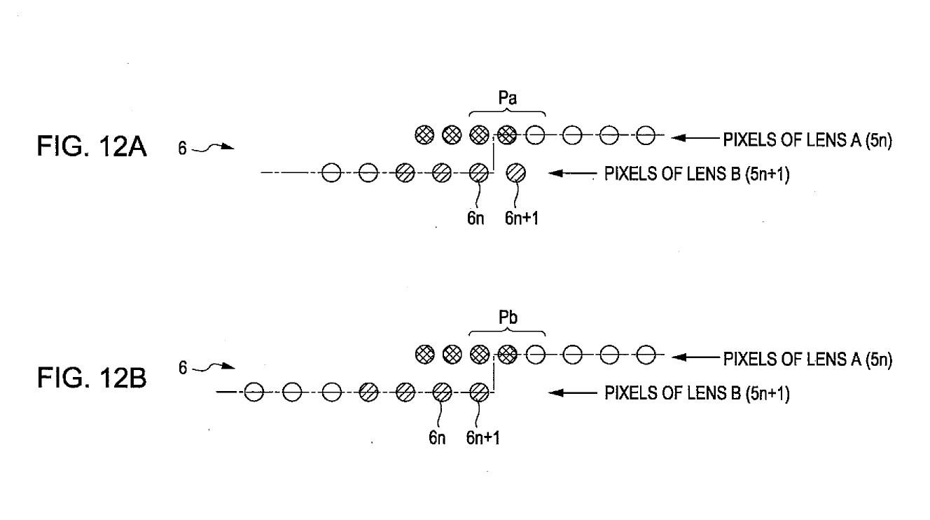

FIG. 12 is an illustrative view showing the relation between a pitch of the connected MLAs and pixels. FIG. 12A shows the case where the pitch between the MLAs connected to each other is narrow. The pixels of the lens A, which are shown as a mesh portion, on the end portion of the MLA 5n in the X direction indicate redundant dots. The pixels of the lens B, which are shown as a shaded portion, on the end portion of the MLA (5n+1) in the X direction indicate redundant dots. The pixels of the MLA 5n and the pixels of the MLA (5n+1) are connected to each other by a dashed line to form one straight line on the photosensitive body. In this instance, the pixel pitch Pa becomes narrow, and the number of the redundant dots is four.

FIG. 12B shows the case where the pitch between the MLAs is wide. In this instance, the pixel pitch Pb becomes narrow, and the number of the redundant dots is five which is increased by one as compared with that of the redundant dots shown in FIG. 12A. According to the printing result of the MLAs, since the number of the dots on one line formed by the MLA head is increased, a line appears in a direction perpendicular to one line formed by the MLA head (depending on the circumstances, in a transport direction of printing paper). In the case where the line is formed in the regular dot arrangement, the regularity collapses, so that the visibility increases, in other words, the image quality is deteriorated.

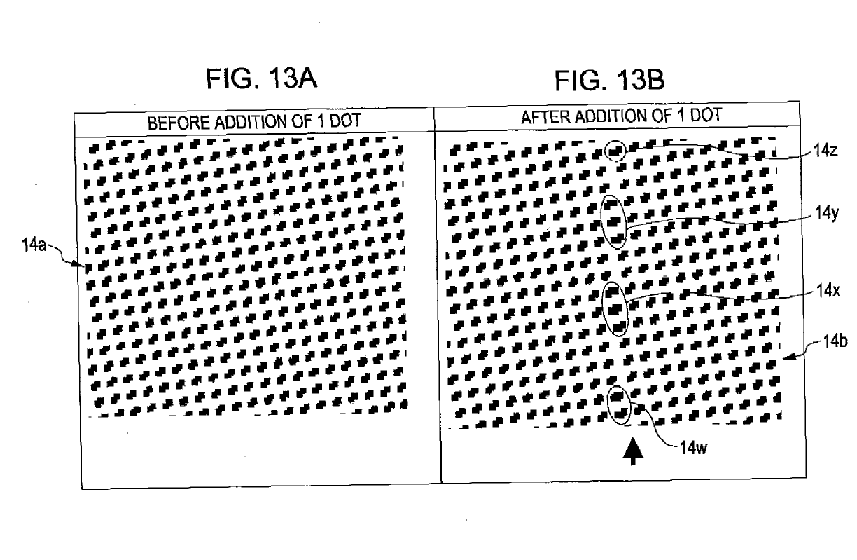

FIG. 13 is an illustrative view showing an example of an output image in the case of employing an AM screen having a screen angle of 15°. FIG. 13A corresponds to FIG. 12A, and shows an output image 14a before the addition of one dot. FIG. 13B corresponds to FIG. 12B, and shows an output image 14b after the addition of one dot. The output image 14b is formed with portions 14x, 14y, 14z and 14w designated by an arrow, in which the number of dots is increased.

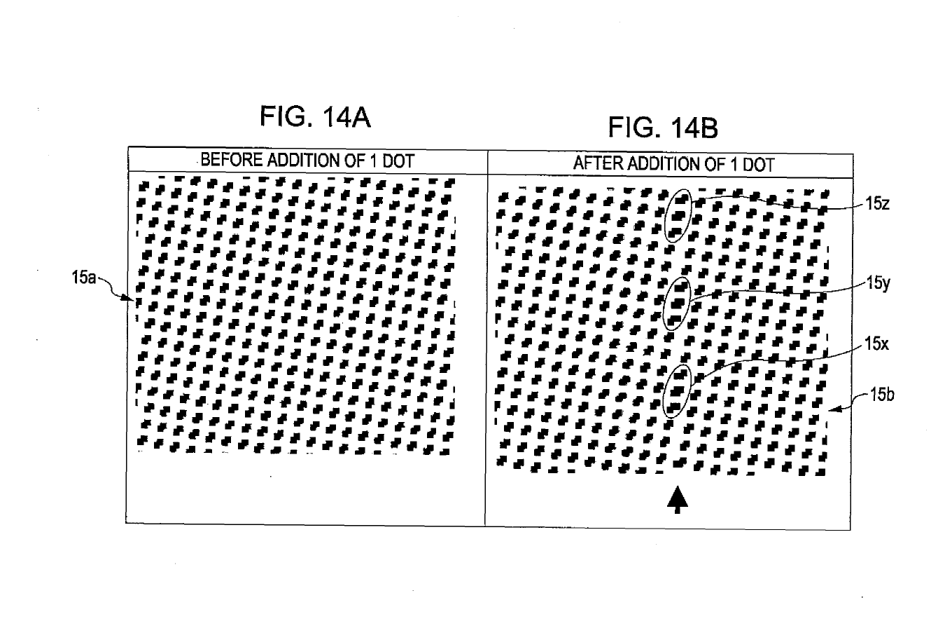

FIG. 14 is an illustrative view showing an example of an output image in the case of employing an AM screen having a screen angle of 75°. FIG. 14A corresponds to FIG. 12A, and shows an output image 15a before the addition of one dot. FIG. 14B corresponds to FIG. 12B, and shows an output image 15b after the addition of one dot. The output image 15b is formed with portions 15x, 15y, and 15z designated by an arrow, in which the number of dots is increased. As shown in FIGS. 13 and 14, periodical non-uniform density is created on the screen-processed output image depending upon an angle of the screen and the number of lines.

In this embodiment of the invention, in the case where the physical dots are increased due to a variation between pitches of each connected portion of the MLAs or a resist difference between the MLAS, the screen table (screen data) for reducing deterioration in the image quality is used. The embodiment of the invention is characterized in that since the redundant dots generated on the output image is not easily visually seen by the screen processing as described above, it reduces deterioration in the image quality. A dot having a different size in a main scanning direction is used on the screen dots (a group of dots formed by the screen). The size, in the main scanning direction, of the screen dot is set to a size n, in the main scanning direction, of the basic dot and a size m·i (i>0, and m may be plural number) in the main scanning direction which is caused by the increase of the redundant dots. The gray scale of the printed image is formed by dispersing the screen dots of sizes n and m.

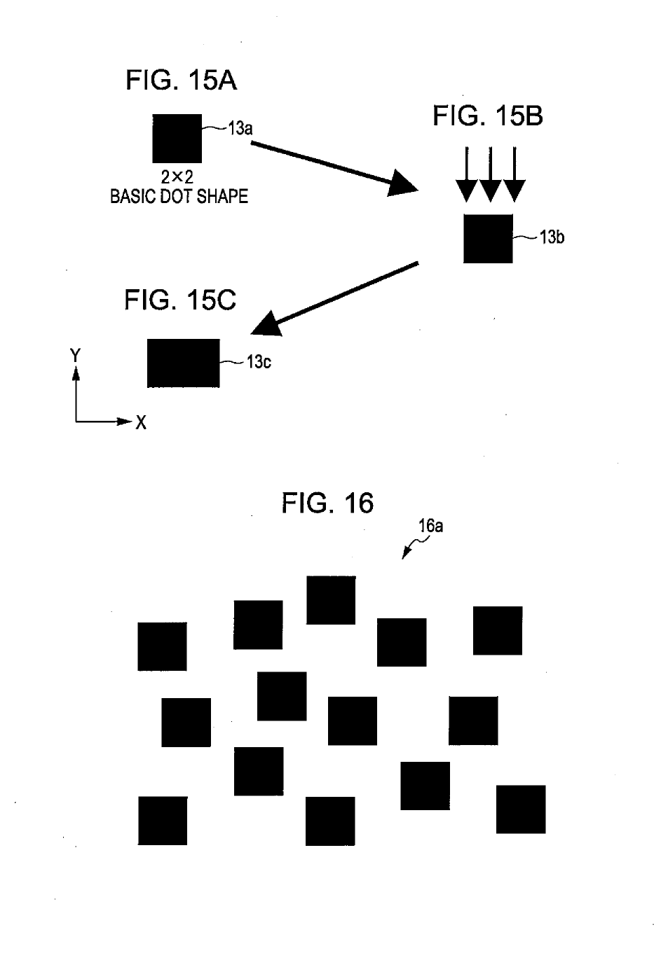

FIG. 15 is an illustrative view showing the basic configuration of the screen dot formation according to the embodiment of the invention. FIG. 15A shows a screen dot 13a of which 2×2 (pixels) is a basic dot. The screen dot 13a corresponds to the first pixel formed as n luminous element spots in the X direction (the first direction). FIG. 15B shows a dot-shaped screen dot 13b (position of arrow) which may be formed by an increase of one dot. FIG. 15C shows a screen dot 13c in which the redundant dot is formed in the X direction. The screen dot 13c corresponds to the second pixel formed as m luminous element spots in the first direction.

FIG. 16 is an illustrative view showing an output image in the case of employing the screen data. FIG. 16 shows an output image 16a formed in the case of using the screen data, of which 2×2 (pixels) is a basic dot, as described in FIG. 15A. FIG. 16 is a case where there is no pitch difference in the dots of the MLAs, and an intended screen image is outputted as printing result.

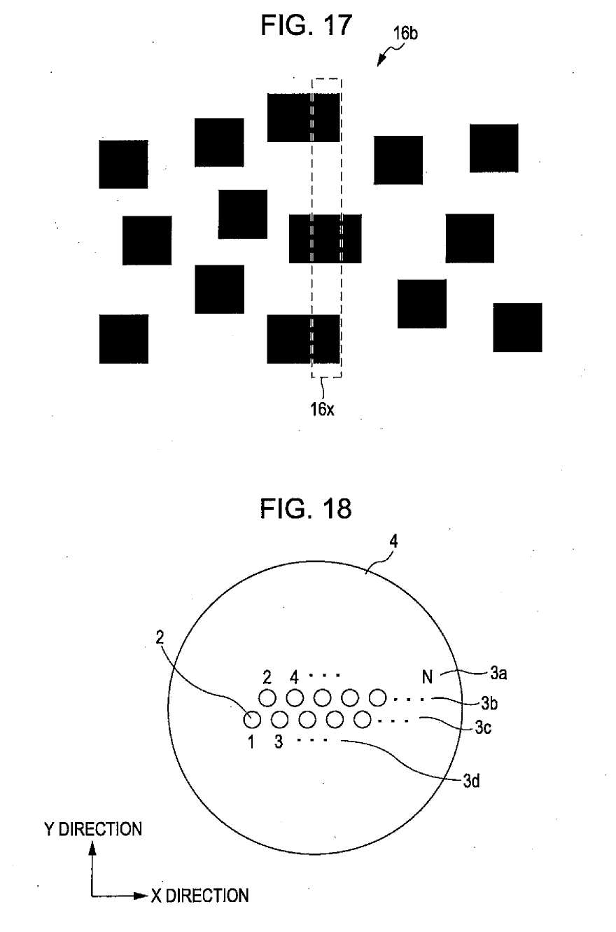

FIG. 17 is an illustrative view showing an output image 16b in the case where a dot size of the screen data is constant and increased by one dot. If the redundant dot is increased by one dot by the pitch difference in the dots of the MLAs, as shown in FIG. 17, the dot shape of the increased column 16x is changed, so that the intended output result is not obtained. The case where the number of the dots of MLAs is increased by one dot means that the number of the dots on one line formed by the MLA head is increased by one dot. The increased number of the dots causes the dot size to locally increase, and a portion designated by a broken line is visible as a vertical line. Therefore, the quality of the output image is deteriorated.

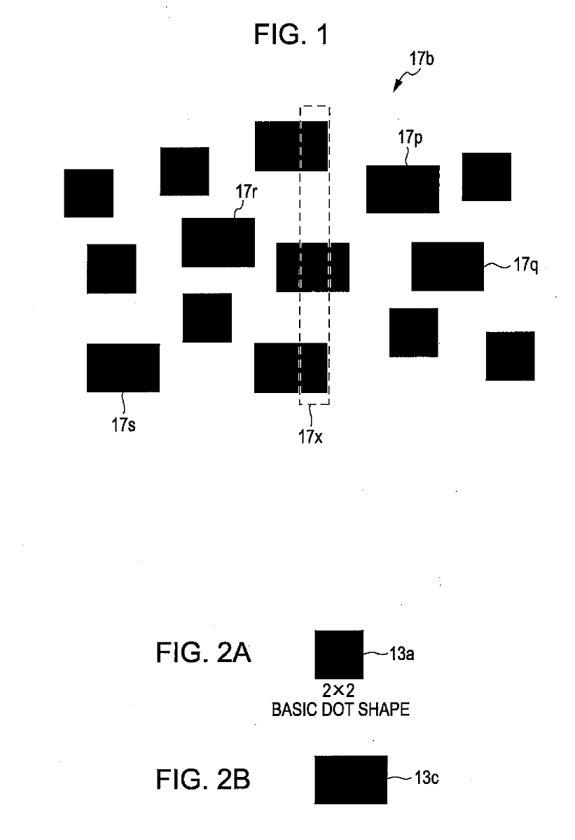

The embodiment of the invention reduces deterioration in image quality due to the vertical line by utilizing an FM screen and devising a dot shape. FIGS. 1 to 8 are illustrative views showing an embodiment of the invention. FIG. 2A shows one example in which 2×2 (pixels) is a basic dot shape 13a of the FM screen. FIG. 2B shows a screen dot shape 13c which may be formed in the case where the number of the dots on the MLAs is increased by one dot.

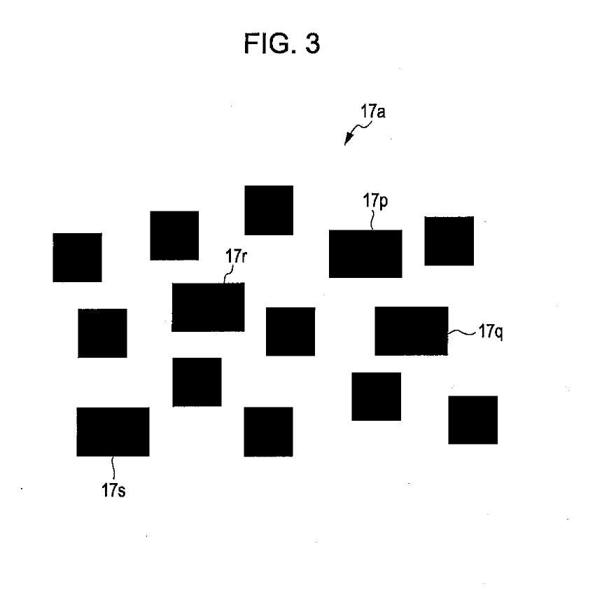

FIG. 3 shows an output image 17a formed by the screen data having the dot shape shown in FIGS. 2A and 2B. In the example of FIG. 3, the gray scale of the output image 17a is represented by dispersing and disposing the dot shapes 13a and 13c different from the screen data. The pixels having the dot shape 13c are dispersed at positions 17p, 17q, 17r and 17s, and are disposed as the output image 17a.

FIG. 1 shows an output image 17b in the case where the redundant dots are increased by one dot due to the pitch difference in the connected portions of the MLAs. It is difficult to visually feel the portion 17x of the increased dot size by dispersing and disposing the dot shapes 17p to 17s which may be formed on the screen data when one dot is increased in the X direction. In other words, the vertical line of the dotted portion is not emphasized in order to reduce the deterioration in image quality of the output image.

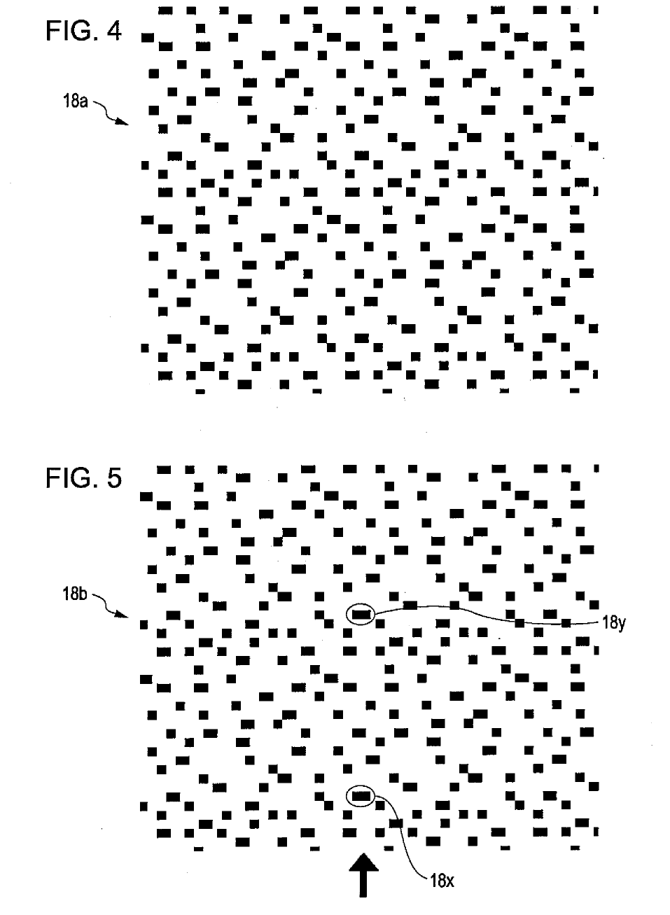

FIG. 4 is an illustrative view showing an output image 18a in the state where a redundant dot is not added as the screen data. FIG. 5 is an illustrative view showing an output image 18b in the state where a redundant dot is added as the screen data. As shown in FIG. 5, the output image 18b is formed with portions 18x and 18y at the position indicated by arrow in the figure, in which the number of the dots is increased, after the addition of one dot.

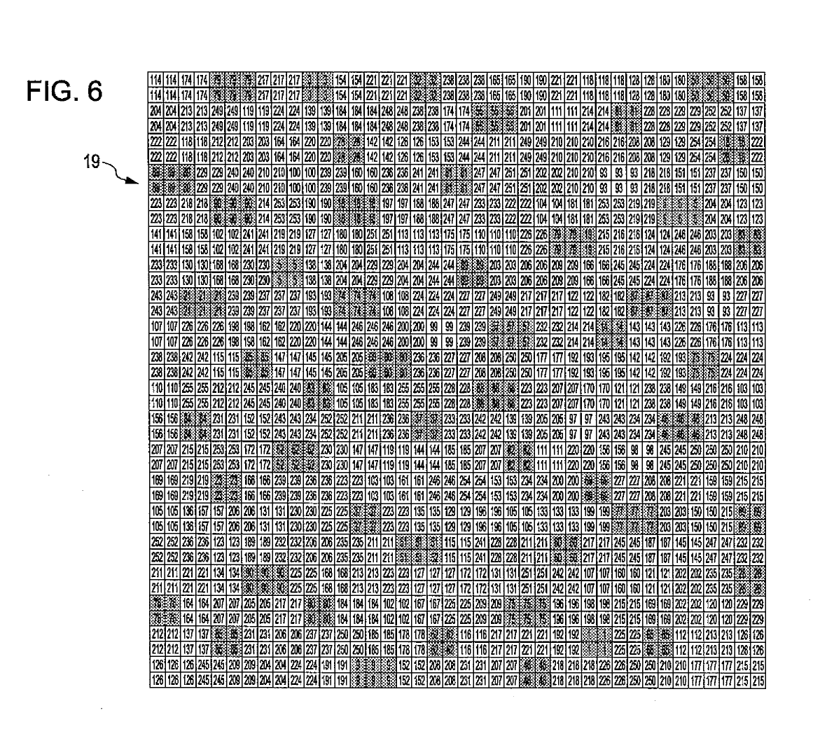

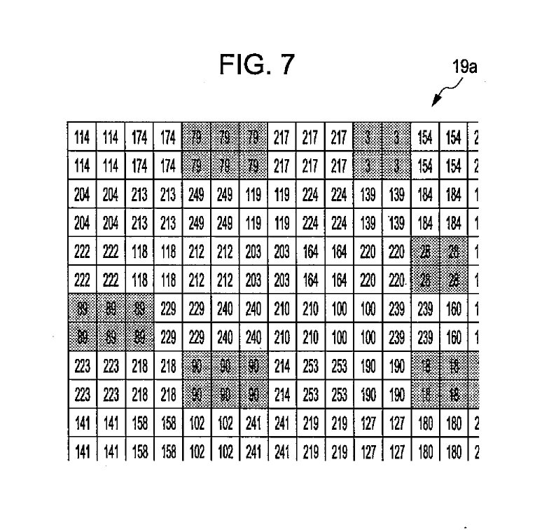

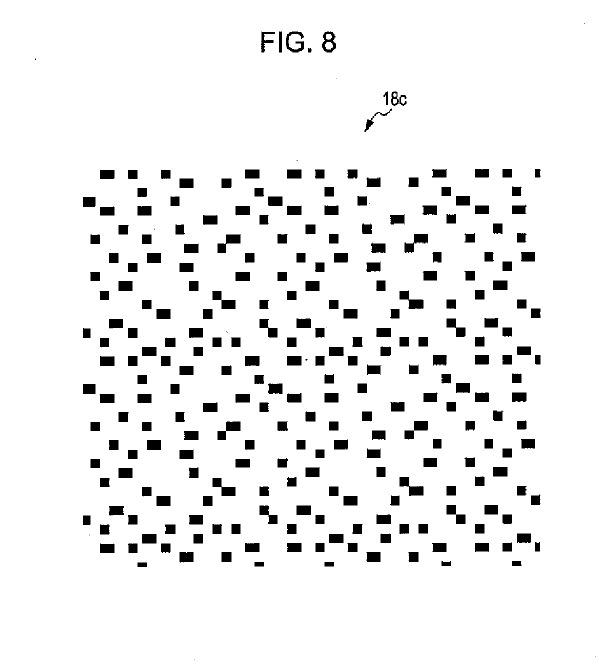

FIGS. 6 and 7 are illustrative views showing an example of a screen table (screen data) 19. The screen table represents a non-stochastic dither. On the dots in the box shown in the figure, a case in which the dot is turned on is shown, in gray scale values 1 to 90 of original images. FIG. 7 shows a portion 19a of which a portion of the screen table 19 shown in FIG. 6 is enlarged. FIG. 8 shows an output image 18c processed by the screen table 19 in FIG. 6, in the gray scale values 1 to 90 of the original image.

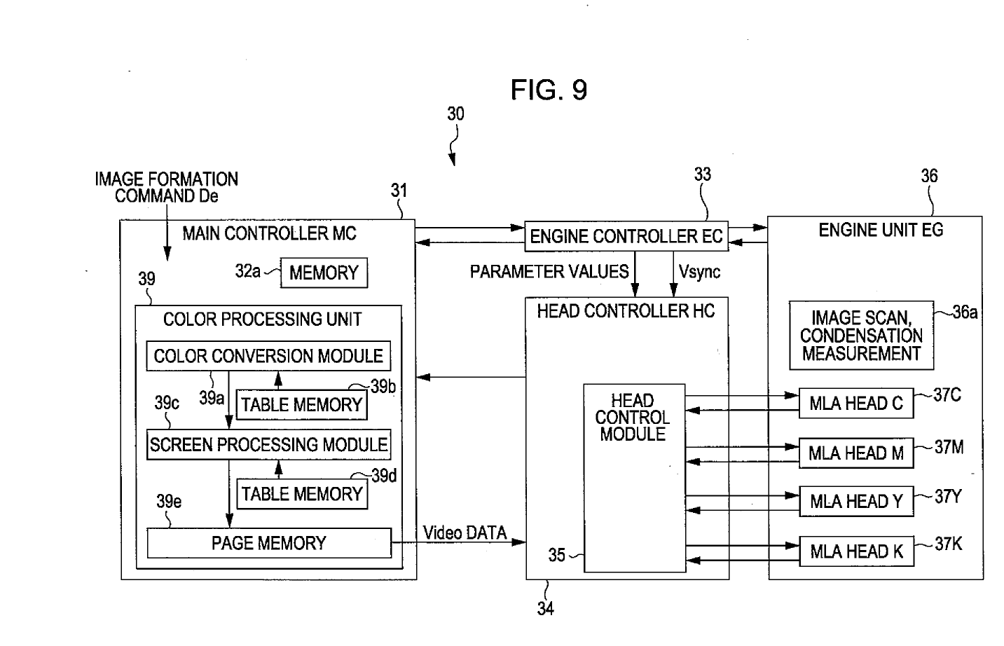

FIG. 9 is a block diagram showing an embodiment of the invention. In FIG. 9, reference numeral 30 denotes an image forming apparatus (printer) including a main controller (MC) 31, an engine controller (EC) 33, a head controller (HC) 34, and an engine unit (EG) 36. The image forming apparatus outputs an image formation command from a printer server which is not shown, such as an outer PC or the like, to the main controller (MC) 31.

The main controller (MC) 31 is provided with a memory 32a storing solid information on, for example, the redundant dot of the MLA and so forth, a color conversion module 39a, and a table memory 39b having the table data for the color conversion module. Also, the main controller 31 is provided with a screen processing module 39c, a table memory 39d having table data for the screen processing module, and a page memory 39e storing printed image data. The memory 32a stores data from the engine controller (EC) 33 and the head controller (HC) 34.

The head controller (HC) 34 is provided with a head control module 35. The head control module 35 transmits print data to MLA heads 37C, 37M, 37Y and 37K of four colors, for example, cyan C, magenta M, yellow Y, and black K. The engine controller (EC) 33 controls the head control module 35 and the engine unit (EG) 36. The engine unit (EG) 36 is provided with an image scan/condensation measuring part 36a for scanning an image to measure condensation.

In FIG. 9, a print command is transmitted from the main controller (MC) 31 to the engine controller (EC) 33, and the main controller (MC) 31 creates a print pattern and transmits the data V stored in the page memory 39e to the head controller (HC) 34. The engine controller (EC) 33 controls the printing carried out by the engine unit (EG) 36, and the head controller (HC) 34 transmits the print data to the MLA head 37C to 37K. After printing, the engine unit 36 sends the data obtained from the scanned image and the measured concentration of the image to the main controller (MC) 31. The scanning of the image and the measurement of the concentration of the image may be performed by an additional device of the image forming unit 30, for example, the head controller (HC) 34.

The main controller (MC) 31 determines whether or not the intended print result is obtained in accordance with the received scan data and the received measured concentration data, and executes feedback control for the image processing unit 30. The feedback to the image processing unit 30 changes the color conversion table or parameter values for the color conversion, or the screen table or parameter values for the screen processing.

In the printed image formed on the photosensitive body, the image of first to fourth rows is printed in the rotation direction of the photosensitive body. In this instance, the MLA is turned on for every row to measure the concentration distribution of the printed image by scanning the printed image and thus measure a dot position of the printed image. Next, the measuring result of the dot position of the printed image is reflected in the screen table. This process includes changing the parameter values for color conversion, the screen table, and changing the parameter values for the screen processing.

The above process is repeated in a quantity matching the number of rows of the MLAs. The screen table is prepared by the apparatus having the above function. In this instance, as described in FIG. 1, the screen data having the first pixels formed in the first direction by the n (n is an integer number equal to or more than 1) luminous element spots, and the second pixels formed in the first direction by the m (m is an integer number different from n) luminous element spots is formed. Also, since the screen can differentiate a region, in which a condensation difference occurs, on the basis of the information on the dot position and the information on the concentration distribution in the case of the error diffusion, the error allotting ratio of error allotment can be changed so that the printing result is equal to that of another region.

In the configuration shown in FIG. 9, the main controller (MC) 31 is provided with a memory 32a for storing solid information such as a redundant dot of the MLA corresponding to each color. The memory 32a storing the solid information on the MLA is provided in all of the exposure heads.

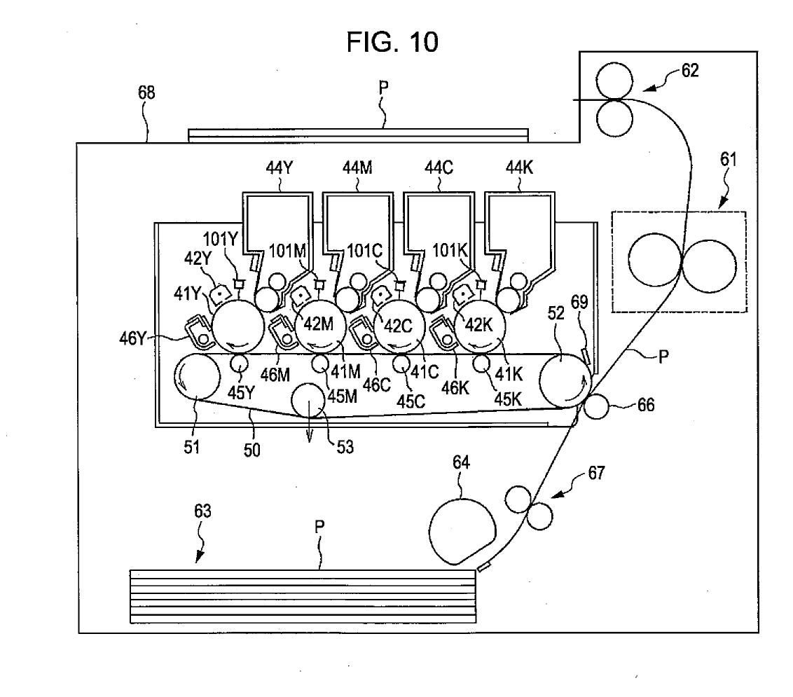

The embodiment of the invention relates to a line head employed in a tandem color printer (image forming apparatus) which can expose four photosensitive bodies by four line heads to simultaneously form an image of four colors, and transfer the image onto an endless-type middle transfer belt (i.e., middle transfer medium). FIG. 10 is a cross-sectional view showing the tandem image forming apparatus employing an organic EL element as a luminous element according to an embodiment of the invention. The image forming apparatus includes four line heads 101K, 101C, 101M and 101Y which have the same structure and are disposed at exposure positions of four corresponding photosensitive bodies 41K, 41C, 41M and 41Y (i.e., image carriers) which have the same structure.

As shown in FIG. 10, the image forming apparatus includes a driving roller 51, a driven roller 52, and a tension roller 53, and includes a middle transfer belt 50 which is circulated by the tension roller 53 in the direction (i.e., counterclockwise direction) indicated by the arrow in FIG. 10. Photosensitive bodies 41K, 41C, 41M and 41Y are disposed against the middle transfer belt 50 at a predetermined interval. Suffixes K, C, M and Y attached to the reference numeral mean black, cyan, magenta and yellow, respectively. The photosensitive bodies 41K to 41Y are rotated in the direction (i.e., a clockwise direction) of the arrow in FIG. 10 in synchronization with the driving of the middle transfer belt 50. Each of the photosensitive bodies 41K to 41Y is provided with charging means 42K to 42Y and exposure heads 101K to 101Y around the photosensitive body.

Also, the image forming apparatus includes a developer unit 44K to 44Y for applying a toner, which is a developer, to the electrostatic latent image formed on the exposure heads 101K to 101Y to develop the latent image as a visible image, primary transfer rollers 45K to 45Y, and cleaning units 46K to 46Y. The emission peak wavelength of the respective line heads 101K to 101Y is substantially equal to sensitivity peak wavelength of the photosensitive bodies 41K to 41Y.

Each of black, cyan, magenta and yellow toner images formed by the monochromatic toner image forming stations of four colors is primarily transferred in series to the middle transfer belt 50 by primary transfer bias applied to the primary transfer rollers 45K to 45Y, and the toner images are sequentially superposed on the middle transfer belt 50 to form a full color image. The color image is secondarily transferred to a recording medium P, such as paper, in a secondary transfer roller 66, and passes through a pair of fuser rollers 61 which is a fixing part, so that the color image is fixed on the recording medium P. The recording medium is discharged onto a catch tray 68 by a pair of paper ejection rollers 62.

Reference numeral 63 denotes a paper feeding cassette on which sheets of recording medium P are stacked, 64 denotes a pick-up roller for feeding one sheet of the recording medium P one by one from the paper feeding cassette 63, 67 denotes a pair of gate rollers for regulating the supply timing of the recording medium P to the secondary transfer portion of the secondary transfer roller 66, 66 denotes the secondary transfer roller (secondary transfer means) for forming the secondary transfer portion between the middle transfer belt 50 and the secondary transfer roller, and 69 denotes a cleaning blade for removing the toner remaining on a surface of the middle transfer belt 50 after the secondary transfer.

Although the image forming apparatus and the image forming method which can reduce the deterioration in image quality according to the invention have been described with reference to the embodiment, the invention is not limited thereto, and it is intended that various modifications may be made.

The entire disclosure of Japanese Patent Applications No. 2008-263840, filed on Oct. 10, 2008 is expressly incorporated by reference herein.

What is claimed is:

1. An image forming apparatus comprising:
an image data input unit to which image data is input;
a latent image carrier;
an exposure head having a luminous element disposed in a first direction, and an imaging optical system for imaging light from the luminous element onto the latent image carrier; and
an image processing unit that screen-processes the image data by using a screen table having a first screen pixel formed by n (n is an integer number equal to or more than 1) luminous element spots in a first direction and a second screen pixel formed by m (m is an integer number different from n) luminous element spots in the first direction.

2. The image forming apparatus according to claim 1, wherein the m is n+1.

3. The image forming apparatus according to claim 1, wherein in the screen table, the first screen pixel and the second screen pixel are dispersed in the first direction and a second direction orthogonal to the first direction.

4. The image forming apparatus according to claim 1, wherein the imaging optical system has negative optical magnification, and is disposed in the first direction of a lens array.

5. The image forming apparatus according to claim 4, wherein the lens array is disposed in the first direction.

6. The image forming apparatus according to claim 1, wherein the screen processing using the screen table compensates for the deterioration of an image formed on the latent image carrier which is caused by a line of the second direction.

7. The image forming apparatus according to claim 1, wherein the screen table is formed by a non-stochastic dither.

8. A method of forming an image comprising:
providing an exposure head having an imaging optical system having negative optical magnification, and a luminous element disposed in a first direction, in which an image is formed in the first direction by the imaging optical system;
screen-processing input image data by using a screen table having a first screen pixel formed by n (n is an integer number equal to or more than 1) luminous element spots in the first direction and a second screen pixel formed by m (m is an integer number different from n) luminous element spots in the first direction;
forming a latent image on a latent image carrier by using the exposure head according to the screen-processed data; and
developing the formed latent image by a developing unit.
